(19) United States
(12) Patent Application Publication
(10) Pub. No.: US 2006/0004983 A1
(43) Pub. Date: Jan. 5, 2006

(54) Method, system, and program for managing memory options for devices

(76) Inventors: Gary Y. Tsao, Austin, TX (US); Quang T. Le, Austin, TX (US); Ashish V. Choubal, Austin, TX (US); Hemal V. Shah, Austin, TX (US)

Correspondence Address: KONRAD RAYNES & VICTOR , LLP, Suite 210, 315 S. Beverly Drive, Beverly Hills, CA, 90212, US

(21) Appl. No.: 10/882,986

(22) Filed: Jun. 30, 2004

(51) Int. Cl. G06F 12/08

(52) U.S. Cl. 711/202; 711/118

(57) ABSTRACT

Provided are a method, system, and program for managing memory options for a device such as an I/O device. Private addresses provided by logic blocks within the device may be transparently routed to either an optional external memory or to system memory, depending upon which of the optional memories the private address has been mapped.

### BACKGROUND

Description of Related Art

In a network environment, a network adapter on a host computer, such as an Ethernet controller, Fibre Channel controller, etc., will receive Input/Output (I/O) requests or responses to I/O requests initiated from the host. Often, the host computer operating system includes a device driver to communicate with the network adapter hardware to manage I/O requests to transmit over a network. The host computer may also employ a protocol which packages data to be transmitted over the network into packets, each of which contains a destination address as well as a portion of the data to be transmitted. Data packets received at the network adapter are often stored in a packet buffer in the host memory. A transport protocol layer can process the packets received by the network adapter that are stored in the packet buffer, and access any I/O commands or data embedded in the packet.

For instance, the computer may employ the TCP/IP (Transmission Control Protocol (TCP) Internet Protocol (IP)) to encode and address data for transmission, and to decode and access the payload data in the TCP/IP packets received at the network adapter. IP specifies the format of packets, also called datagrams, and the addressing scheme. TCP is a higher level protocol which establishes a connection between a destination and a source.

A device driver, application or operating system can utilize significant host processor resources to handle network transmission requests to the network adapter. One technique to reduce the load on the host processor is the use of a TCP/IP Offload Engine (TOE) in which TCP/IP protocol related operations are embodied in the network adapter hardware as opposed to the device driver or other host software, thereby saving the host processor from having to perform some or all of the TCP/IP protocol related operations.

Offload engines and other devices frequently utilize memory, often referred to as a buffer, to store or process data. Buffers have been provided using physical memory which stores data, usually on a short term basis, in integrated circuits, an example of which is a random access memory or RAM. Typically, data can be accessed relatively quickly from such physical memories. A host computer often has additional physical memory such as hard disks and optical disks to store data on a longer term basis. These nonintegrated circuit based physical memories tend to retrieve data more slowly than the integrated circuit physical memories.

The operating system of a computer typically utilizes a virtual memory space which is often much larger than the memory space of the physical memory of the computer. FIG. 1 shows an example of a virtual memory space 50 and a short term physical memory space 52. The memory space of a long term physical memory such as a hard drive is indicated at 54. The data to be sent in a data stream or the data received from a data stream may initially be stored in noncontiguous portions, that is, nonsequential memory addresses, of the various memory devices. For example, two portions indicated at 10a and 10b may be stored in the physical memory in noncontiguous portions of the short term physical memory space 52 while another portion indicated at 10c may be stored in a long term physical memory space provided by a hard drive as shown in FIG. 2. The operating system of the computer uses the virtual memory address space 50 to keep track of the actual locations of the portions 10a, 10b and 10c of the datastream 10. Thus, a portion 50a of the virtual memory address space 50 is mapped to the actual physical memory addresses of the physical memory space 52 in which the data portion 10a is stored. In a similar fashion, a portion 50b of the virtual memory address space 50 is mapped to the actual physical memory addresses of the physical memory space 52 in which the data portion 10b is stored. In another example, the datastream 10 is typically continuous in virtual memory address space while mapped into noncontiguous said physical memory space. Furthermore, a portion 50c of the virtual memory address space 50 is mapped to the physical memory addresses of the long term hard drive memory space 54 in which the data portion 10c is stored. A blank portion 50d represents an unassigned or unmapped portion of the virtual memory address space 50.

FIG. 2 shows an example of a typical Address Translation Table (ATT) 60 which the operating system utilizes to map virtual memory addresses to real physical memory addresses. Thus, the virtual memory address of the virtual memory space 50a may start at virtual memory address 0X1000, for example, which is mapped to a physical memory address 8AEF000, for example of the physical memory space 52. The ATT table 60 does not have any physical memory addresses which correspond to the virtual memory addresses of the virtual memory address space 50d because the virtual memory space 50d has not yet been mapped to physical memory space. ATT is typically located in system memory.

In known systems, portions of the virtual memory space 50 may be assigned to a device or software module for use by that module so as to provide memory space for buffers. Also, an Input/Output (I/O) device such as a network adapter or a storage controller may have a local memory such as a sideRAM coupled to the device. Access to such a local memory is typically limited to the I/O device. Hence, the I/O device may have a private memory address space unique to the device to address memory locations within the local memory.

Recent developments in host interfaces, such as the PCI Express, for example, can increase available host memory bandwidth and reduce host memory access latency for each device as compared to some prior host interfaces such as the commonly used PCI bus. As a result, host memory may be a viable a substitute for local memory in some applications.

Notwithstanding, there is a continued need in the art to improve the cost and performance of memory usage in data transmission and other operations.

### BRIEF DESCRIPTION OF THE DRAWINGS

Referring now to the drawings in which like reference numbers represent corresponding parts throughout:

FIG. 1 illustrates prior art virtual and physical memory addresses of a system memory in a computer system;

FIG. 2 illustrates a prior art system virtual to physical memory address translation and protection table;

FIG. 3 illustrates an architecture that may be used with the described embodiments;

FIG. 4 illustrates an embodiment of a computing environment in which aspects of the description provided he rein are embodied;

FIG. 5 illustrates a prior art packet architecture;

FIG. 6 illustrates one embodiment of an I/O device architecture which can optionally be coupled to a side memory as well as system memory in accordance with one embodiment of the present description;

FIG. 7 illustrates optional mapping of an I/O device private memory space to memory spaces of one or both of a side memory and a system memory in accordance with one embodiment of the present description;

FIG. 8 illustrates one embodiment of operations to perform optional mapping of an I/O device private memory space to memory spaces of one or both of a side memory and a system memory in accordance with one embodiment of the present description;

FIG. 9 illustrates one example of a memory cluster subsystem architecture for the I/O device of FIG. 6 memory in accordance with one embodiment of the present description;

FIG. 10 illustrates one embodiment operations of a memory cluster subsystem, to carry out a memory operation such as reading or writing data such as a data structure at one of various optional memories;

FIG. 11 illustrates one embodiment of a private address space for an I/O device in accordance with aspects of the description;

FIG. 12 illustrates one embodiment of mapping tables for mapping private addresses to system memory addresses; and

FIG. 13 illustrates an embodiment of a private address for addressing memory entries.

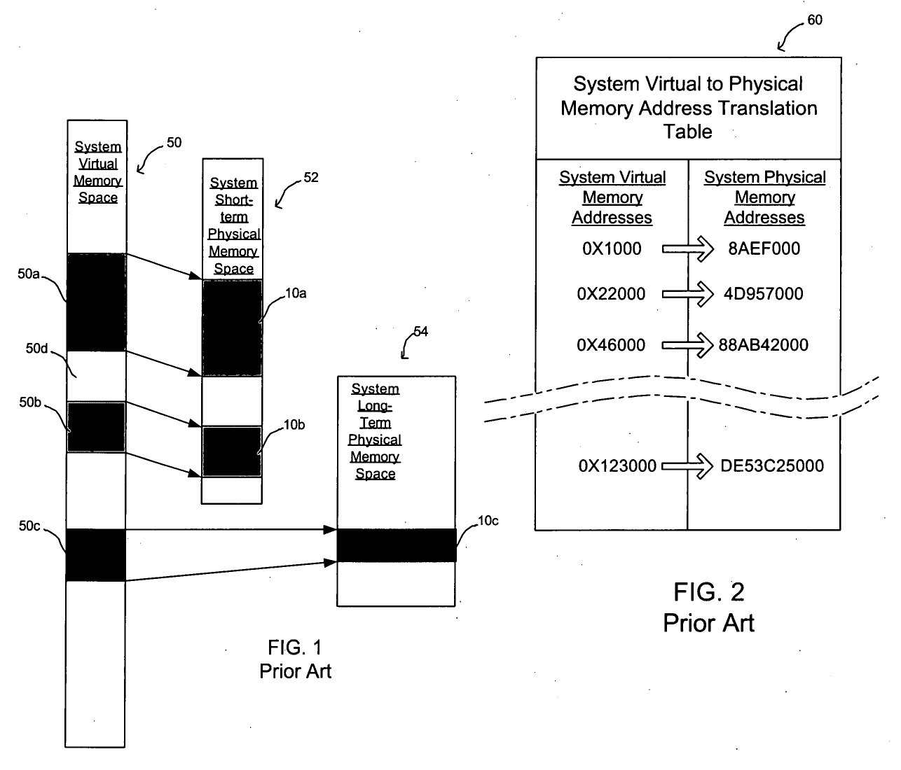

### DETAILED DESCRIPTION OF ILLUSTRATED EMBODIMENTS

In the following description, reference is made to the accompanying drawings which form a part hereof and which illustrate several embodiments of the present disclosure. It is understood that other embodiments may be utilized and structural and operational changes may be made without departing from the scope of the present description.

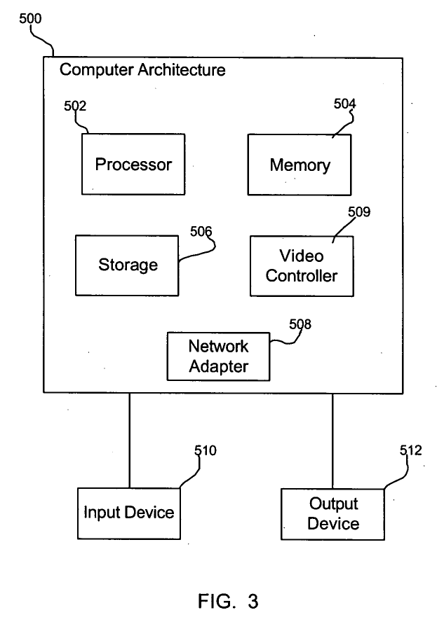

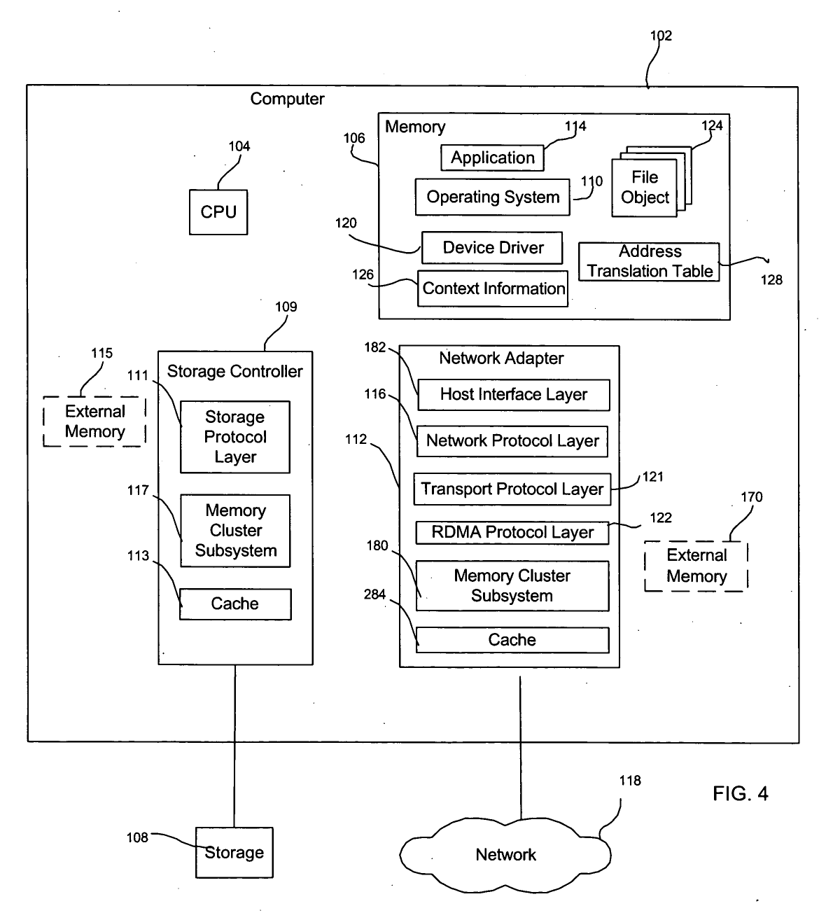

FIGS. 3 and 4 illustrate examples of computing environments in which aspects of described embodiments may be employed. For example, FIG. 4 shows a computer 102 which includes one or more central processing units (CPU) 104 (only one is shown), a memory 106, non-volatile storage 108, a storage controller 109, an operating system 110, and a network adapter 112. An application 114 further executes in memory 106 and is capable of transmitting and receiving packets from a remote computer. The computer 102 may comprise any computing device known in the art, such as a mainframe, server, personal computer, workstation, laptop, handheld computer, telephony device, network appliance, virtualization device, storage controller, storage controller, etc. Any CPU 104 and operating system 110 known in the art may be used. Applications and data in memory 106 may be swapped into storage 108 as part of memory management operations.

The storage controller 109 controls the reading of data from and the writing of data to the storage 108 in accordance with a storage protocol layer 111. The storage protocol of the layer 111 may be any of a number of known storage protocols including Redundant Array of Independent Disks (RAID), High Speed Serialized Advanced Technology Attachment (SATA), parallel Small Computer System Interface (SCSI), serial attached SCSI, etc. Data being written to or read from the storage 108 may be cached in a cache 113 in accordance with known caching techniques. The storage controller 109 may optionally have an external memory 115. The storage controller may be integrated into the CPU chipset, which can include various controllers including a system controller, peripheral controller, memory controller, hub controller, I/O bus controller, etc.

The network adapter 112 includes a network protocol layer 116 to send and receive network packets to and from remote devices over a network 118. The network 118 may comprise a Local Area Network (LAN), the Internet, a Wide Area Network (WAN), Storage Area Network (SAN), etc. Embodiments may be configured to transmit data over a wireless network or connection, such as wireless LAN, Bluetooth, etc. In certain embodiments, the network adapter 112 and various protocol layers may employ the Ethernet protocol over unshielded twisted pair cable, token ring protocol, Fibre Channel protocol, Infiniband, etc., or any other network communication protocol known in the art. The network adapter controller may be integrated into the CPU chipset, which, as noted above, can include various controllers including a system controller, peripheral controller, memory controller, hub controller, I/O bus controller, etc.

A device driver 120 executes in memory 106 and includes network adapter 112 specific commands to communicate with a network controller of the network adapter 112 and interface between the operating system 110, applications 114 and the network adapter 112. The network controller can embody the network protocol layer 116 and can control other protocol layers including a data link layer and a physical layer which includes hardware such as a data transceiver.

In certain embodiments, the network controller of the network adapter 112 includes a transport protocol layer 121 as well as the network protocol layer 116. For example, the network controller of the network adapter 112 can employ a TCP/IP offload engine, in which many transport layer operations can be performed within the network adapter 112 hardware or firmware, as opposed to the device driver 120 or host software.

The transport protocol operations include packaging data in a TCP/IP packet with a checksum and other information and sending the packets. These sending operations are performed by an agent which may be embodied with a TOE, a network interface card or integrated circuit, a driver, TCP/IP stack, a host processor or a combination of these elements. The transport protocol operations also include receiving a TCP/IP packet from over the network and unpacking the TCP/IP packet to access the payload or data. These receiving operations are performed by an agent which, again, may be embodied with a TOE, a driver, a host processor or a combination of these elements.

The network layer 116 handles network communication and provides received TCP/IP packets to the transport protocol layer 121. The transport protocol layer 121 interfaces with the device driver 120 or operating system 110 or an application 114, and performs additional transport protocol layer operations, such as processing the content of messages included in the packets received at the network adapter 112 that are wrapped in a transport layer, such as TCP and/or IP, the Internet Small Computer System Interface (iSCSI), Fibre Channel SCSI, parallel SCSI transport, or any transport layer protocol known in the art. The transport offload engine 121 can unpack the payload from the received TCP/IP packet and transfer the data to the device driver 120, an application 114 or the operating system 110.

In certain embodiments, the network controller and network adapter 112 can further include an RDMA protocol layer 122 as well as the transport protocol layer 121. For example, the network adapter 112 can employ an RDMA offload engine, in which RDMA layer operations are performed within the offload engines of the RDMA protocol layer 122 embodied within the network adapter 112 hardware, as opposed to the device driver 120 or other host software.

Thus, for example, an application 114 transmitting messages over an RDMA connection can transmit the message through the device driver 120 and the RDMA protocol layer 122 of the network adapter 112. The data of the message can be sent to the transport protocol layer 121 to be packaged in a TCP/IP packet before transmitting it over the network 118 through the network protocol layer 116 and other protocol layers including the data link and physical protocol layers.

The memory 106 further includes file objects 124, which also may be referred to as socket objects, which include information on a connection to a remote computer over the network 118. The application 114 uses the information in the file object 124 to identify the connection. The application 114 may use the file object 124 to communicate with a remote system. The file object 124 may indicate the local port or socket that will be used to communicate with a remote system, a local network (IP) address of the computer 102 in which the application 114 executes, how much data has been sent and received by the application 114, and the remote port and network address, e.g., IP address, with which the application 114 communicates. Context information 126 comprises a data structure including information the device driver 120, operating system 110 or an application 114, maintains to manage requests sent to the network adapter 112 as described below. The system memory 106 may further include an address translation table (ATT) 128 for translating addresses to system memory addresses.

In the illustrated embodiment, the CPU 104 programmed to operate by the software of memory 106 including one or more of the operating system 110, applications 114, and device drivers 120 provides a host which interacts with the network adapter 112. Accordingly, a data send and receive agent includes the transport protocol layer 121 and the network protocol layer 116 of the network interface 112. However, the data send and receive agent may be embodied with a TOE, a network interface card or integrated circuit, a driver, TCP/IP stack, a host processor or a combination of these elements.

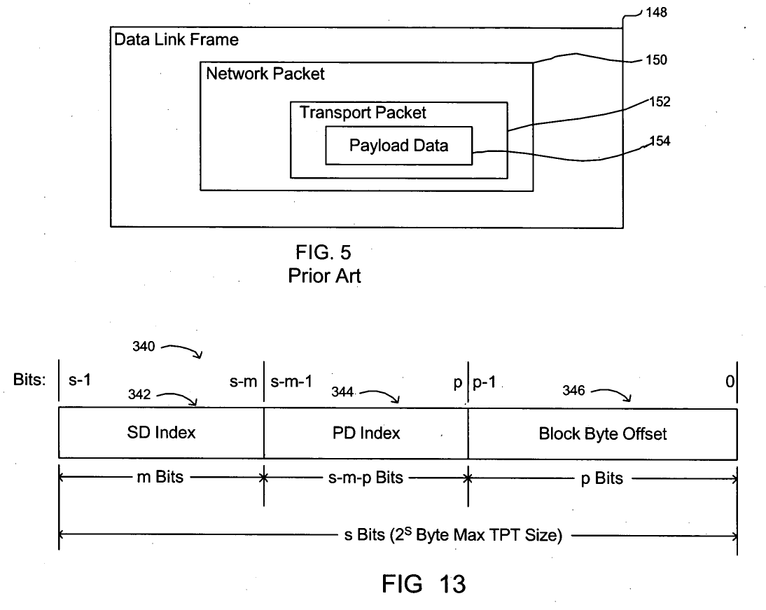

FIG. 5 illustrates a format of a network packet 150 received at or transmitted by the network adapter 112. The data link frame 148 is embodied in a format understood by the data link layer, such as 802.11 Ethernet. Details on this Ethernet protocol are described in “IEEE std. 802.11,” published 1999-2003. An Ethernet frame may include additional Ethernet components, such as a header and an error checking code (not shown). The data link frame 148 includes a network packet 150, such as an IP datagram. The network packet 150 is embodied in a format understood by the network protocol layer 116, such as such as the IP protocol. A transport packet 152 is included in the network packet 150. The transport packet may 152 is capable of being processed by the transport protocol layer 121, such as the TCP. The packet may be processed by other layers in accordance with other protocols including Internet Small Computer System Interface protocol, Fibre Channel SCSI, parallel SCSI transport, etc. The transport packet 152 includes payload data 154 as well as other transport layer fields, such as a header and an error checking code. The payload data 152 includes the underlying content being transmitted, e.g., commands, status and/or data. The driver 120, operating system 110 or an application 114 may include a layer, such as a SCSI driver or layer, to process the content of the payload data 154 and access any status, commands and/or data therein. Details on the Ethernet protocol are described in “IEEE std. 802.3,” published Mar. 8, 2002.

In accordance with one aspect of the description provided herein, a device such as the network adapter 112 may optionally have an associated local or side memory 170 (FIG. 4) which is external to the integrated circuit or circuits with which the network adapter 112 is embodied. If an external memory 170 is coupled to the network adapter 112, logic blocks within the network adapter 112 may address memory locations within the external memory 170 to read or write data.

In addition to the external memory 170, the logic blocks of the network adapter 112 may optionally address memory locations of other memory of the computer 102, such as the system memory 106, for example. Thus, if an external memory 170 is coupled to the network adapter 112, logic blocks or components within the network adapter 112 may optionally address memory locations within either the external memory 170 or the system memory 106, or both, to read or write data. However, if an external memory 170 is not coupled to the network adapter 112, logic blocks within the network adapter 112 may address memory locations within the system memory 106 to read or write data.

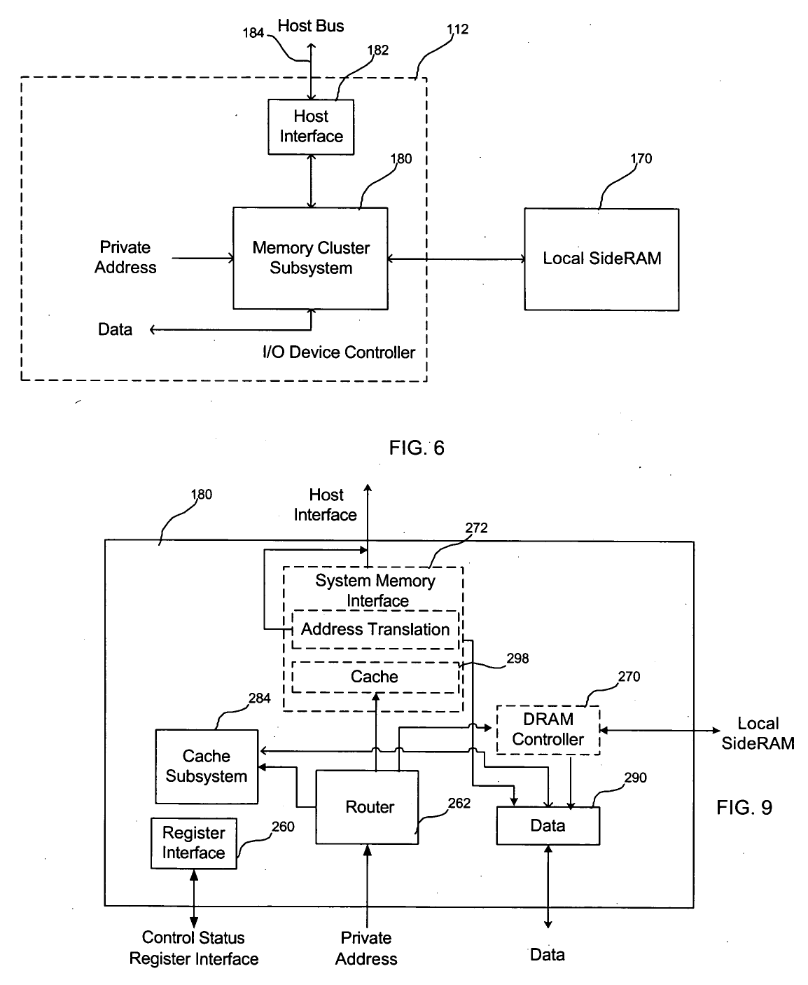

These aspects of the network adapter 112 are conceptually represented in FIG. 6 which shows the network adapter 112 having a memory cluster subsystem or memory controller 180 which receives an address generated by a logic block of the network adapter 112. Each logic block may include one or more of logic circuitry, software and firmware to provide one or more functions of the network adapter 112. In response to receipt of an address from a logic block, the memory cluster 180 directs the address to one of the external memory 170, which may be a local sideRAM, for example, or, to the system memory 106, via a host interface 182 and a host bus 184 coupled to the system memory 106. As explained in greater detail below, the memory cluster 180 may be programmed to selectively direct particular addresses to one of a plurality of memory locations, depending upon the manner in which the memory cluster 180 is programmed.

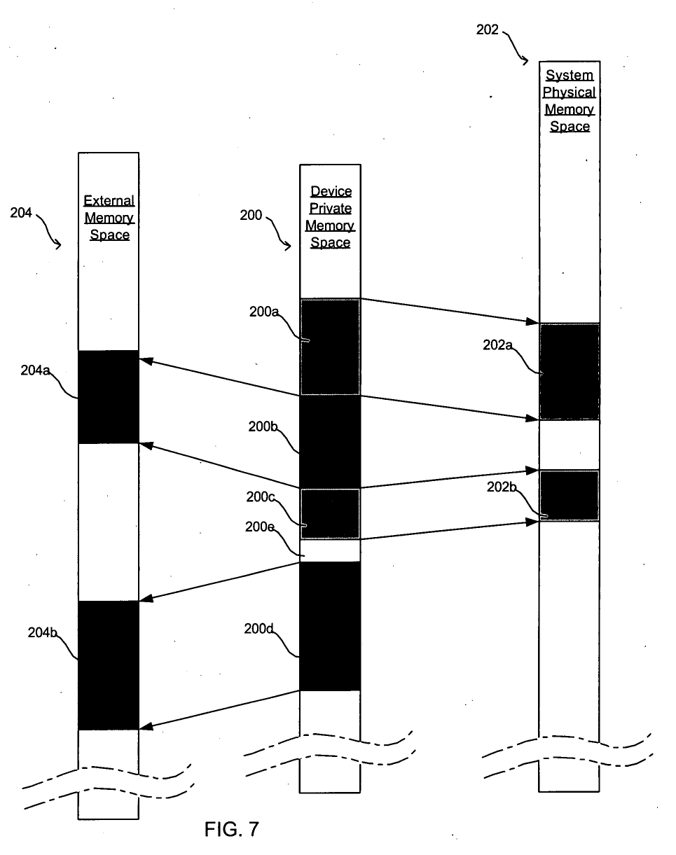

In the illustrated embodiment, the addresses generated by the logic blocks of the network adapter 112 are within an address space which is unique to the network adapter 112. Thus, the addresses are within a private address space which is illustrated schematically at 200 in FIG. 7. Moreover, the private address space 200 may be used universally by all the logic blocks of the network adapter 112 which access memory locations. It is appreciated however, that in alternative embodiments, nonprivate addresses may be used by some or all of the logic blocks.

In accordance with another aspect of an illustrated embodiment, portions of the private address space 200 of the device 112 may be optionally mapped to selected portions of various memories of the computer system 102. Thus, in the example of FIG. 7, a portion 200a of the private address space 200 may be mapped to a selected portion 202a of the system address space 202 which can include the system memory 106 or the storage 108 or both, for example. Similarly, a portion 200b of the private address space 200 may be mapped to a selected portion 204a of the external memory 170 address space if an external memory is coupled to the device 112. Likewise, a portion 200c of the private address space 200 may be mapped to a selected portion 202b of the system address space 202 and a portion 200d of the private address space 200 may be mapped to a selected portion 204b of the external memory 170 address space.

In accordance with yet another aspect of an illustrated embodiment, another portion 200e of the private address space 200 is shown not mapped to memory locations and remains available for mapping to a memory location as needs arise. Also, mapped private address space portions such as portion 200c, for example, may be changed to be mapped to different memory locations within either the system address space 202 or the external memory address space 204, or no memory locations at all, in accordance with changing needs of the system.

In the illustrated embodiment, addresses of the device private address space 200 may be mapped to physical addresses of memory locations, either directly or indirectly. It is appreciated that the addresses of the device private address space 200 may be mapped to virtual addresses and subsequently translated to physical addresses of memory locations, as appropriate.

Also in the illustrated embodiment, device private address space portions such as the portions 200a, 200b and 200c may be contiguous within the private address space 200 yet may be mapped to noncontiguous address space portions such as the system address space portions 202a, 202b and the external memory address space portion 204a.

In addition, the private address space 200 may be partitioned for a variety of uses. For example, different logic blocks of the I/O device may be assigned different partitions of the private address space 200. Although the illustrated embodiment is described in connection with a network adapter 112, aspects of the description provided herein may be embodied in other I/O devices such as a storage controller 109, for example.

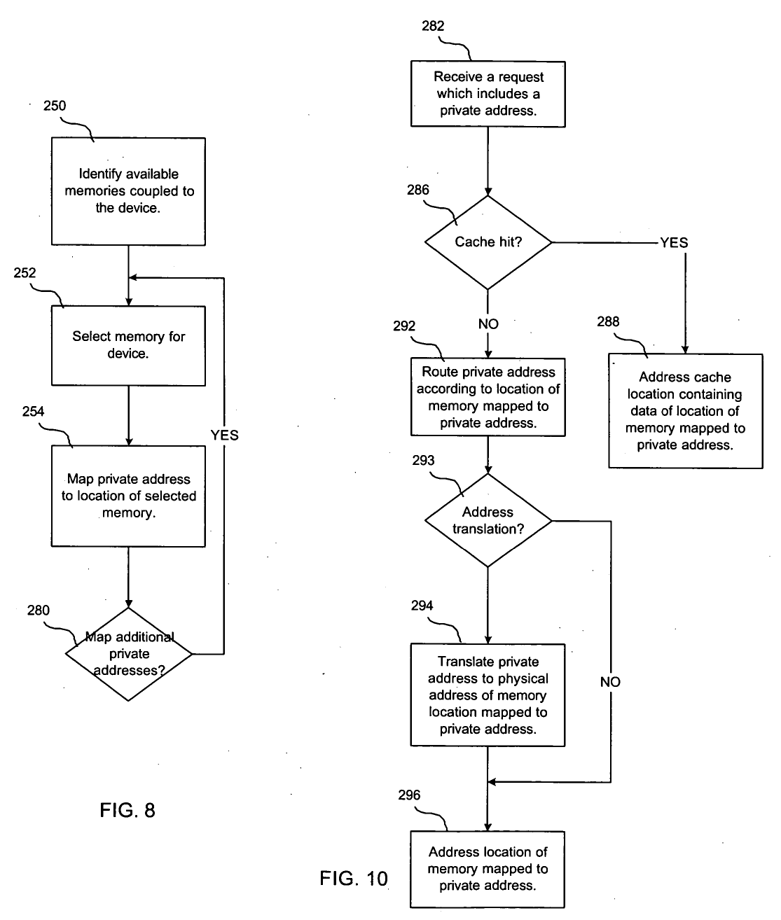

FIG. 8 shows operations of a device driver such as the device driver 120 to initialize the memory cluster subsystem 180 to prepare for memory operations. An identification (block 250) is made as to the available memory or memories coupled to the network adapter 112. In the illustrated embodiment, a determination is made as to whether an external memory such as sideRAM 170, in addition to the system memory such as memory 106 or storage 108, is coupled to the network adapter 112.

From the available memories, a memory is selected (block 252) for use with the network adapter 112. One or more device private addresses may be mapped (block 254) to the selected memory. In the example of FIG. 7, a device private address space portion 200a is mapped to a system address space portion 202a as discussed above. In another example, the entire device private address space 200 could be mapped to various contiguous or noncontiguous portions of the system address space 202. In yet another example, the entire device private address space 200 could be mapped to various contiguous or noncontiguous portions of the external memory address space 204. In yet another example, various portions of the device private address space 200 could be mapped to various contiguous or noncontiguous portions of the system memory address space 202 at the same time other portions of the device private address space 200 could be mapped to various contiguous or noncontiguous portions and the external memory address space 204 as represented in FIG. 7.

In the illustrated embodiment, the memory cluster subsystem 180 has a number of control and status registers which may be accessed by the device driver 120 through a register interface 260 as shown in FIG. 9 The memory cluster subsystem 180 may be configured by the device driver 120 to map a private address or block of private addresses of the private address space 200 to an available memory device (such as the system memory 106 or the external memory 170, for example), by setting one or more control register bits of the register interface 260 as appropriate. A router 262 is responsive to the control registers of the interface 260, to route a private address in accordance with the particular memory device to which the private address or block of private addresses of the private address space 200 is mapped.

In addition to mapping a private address or a block of private addresses of the private address space 200 to an available memory device, the private address may be mapped to a particular memory location or block of memory locations of the selected memory device. In one embodiment, the physical address space of the selected memory device may match at least a portion of the private address space 200 of the device 112. For example, the external memory 170 may have a physical address space 204 which overlaps the address space 200 of the device 112 such that at least some of the private addresses generated by the logic blocks of the device 112 are the same in value and format as the physical addresses of the memory locations of the external memory 170. Accordingly, private addresses mapped to the external memory 170 may be routed to an external memory controller 270 to address memory locations of the external memory 170 directly without any address translation.

Conversely, in many applications an available memory such as a system memory 106 may have an address space 202 which is substantially different in value or format or both, from that of the private address space 200. Accordingly, private addresses mapped to the system memory 106 may be translated by suitable system memory interface subsystem 272 into corresponding physical addresses of the mapped memory locations of the system memory 106 prior to being used to address those memory locations.

A determination (block 280) may be made as to whether additional private addresses are to be mapped to an available memory device. If so, a memory is again selected (block 252) and one or more device private addresses may be mapped (block 254) to the selected memory until (block 280) all of the private addresses have been mapped.

FIG. 10 shows operations of a memory cluster subsystem, such as the subsystem 180 to carry out a memory operation such as reading or writing data such as a data structure at one of various memories. The subsystem 180 may receive (block 282) a request for a memory operation from a logic block or component of an I/O device such as the network adapter 112. The memory location at which the memory operation is to occur is identified by a private address supplied by the logic block. In the illustrated embodiment, the physical location of that memory location, whether in local sideRAM or in other memory such as the system memory, is transparent to the logic block or component using the private address to address a memory location. Hence, a logic block or component can be assigned to use a particular set of private addresses to address memory locations whether or not a local memory is attached to the I/O device.

The memory cluster subsystem 180 may optionally have a cache subsystem 284 to cache data to improve access speeds. If so, the private address may be routed by the router 262 to the cache subsystem 284. A determination (block 286) is made as to whether there is a cache “hit”, that is, whether the memory location entry addressed by the private address is resident in the cache subsystem 284. If so, the cache location containing the data of the memory location mapped to the private address may be addressed (block 288), and the requested data may be returned to the requesting component in a data read operation or may be written to the cache in a data write operation through a register 290.

If there is a cache “miss”, that is, if the memory location entry addressed by the private address is not resident in the cache subsystem 284, the private address is routed (block 292) by the router 262 according to the location of the memory to which the private address has been mapped. Thus, for example, if the private address has been mapped to a memory location within the external memory 170, the private address may be routed to the external memory controller 270, such a Dynamic Random Access Memory (DRAM) controller to be applied (block 296) to the external memory 170.

The physical address space of the selected memory device may match at least a portion of the private address space 200 of the device 112. For example, the external memory 170 may have a physical address space 204 which overlaps the address space 200 of the device 112 such that at least some of the private addresses generated by the logic blocks of the device 112 are the same value and format as the physical addresses of the memory locations of the external memory 170. Accordingly, private addresses mapped to the external memory 170 may be applied by the external memory controller 270 to address (block 296) memory locations of the external memory 170 directly without any address translation (blocks 293, 294).

In another example, if the private address has been mapped to a memory location within the system memory 106, the private address may be routed to the system memory interface subsystem 272. As previously mentioned, an available memory such as a system memory 106 may have an address space 202 which is substantially different from that of the private address space 200. If so, it may be determined (block 293) that translation is needed. Accordingly, private addresses mapped to the system memory 106 may be translated (block 294) by the system memory interface subsystem 272 into corresponding phys ical addresses of the mapped memory locations of the system memory 106 prior to being used to address (block 296) those memory locations.

Private addresses provided by the I/O device may be translated using an address translation table (ATT) which, in the illustrated embodiment, is maintained by the system memory interface 272. Selected portions of the address translation table may be cached in a cache 298 as shown in FIG. 9. The selection of the address translation table entries for caching may be made using known heuristic techniques.

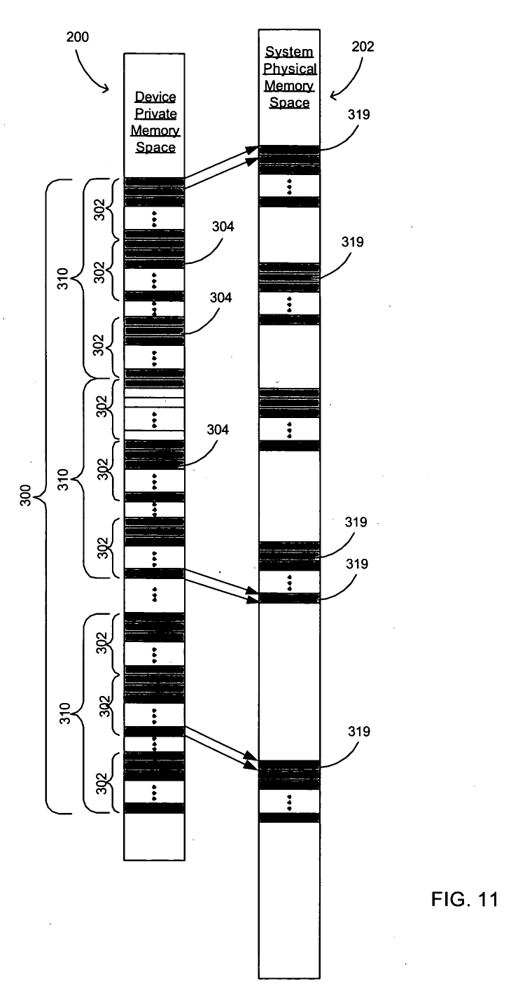

In the illustrated embodiment, a portion or portions 300 of the private address space 200 which are to be translated to system memory addresses, may be subdivided at a first level into a plurality of units or segments 310 as shown in FIG. 11. Each unit or segment 310 may be in turn be subdivided at a second level into a plurality of subunits or subsegments 302. The subsegments 302 are referred to herein as “pages” or “blocks” 302. Each page or block 302 may be in turn subdivided at a third level into a plurality of memory entries 304. It is appreciated that the private address space portion 300 may be subdivided at a greater number or lesser number of hierarchal levels. Individual pages 302 or memory entries 302 may be mapped to corresponding system memory entries 319 or entries of the local memory 170.

In the illustrated embodiment, each of the segments 310 of the address space portion 300 is of equal size, each of the pages 302 of the private address space portion 300 is of equal size and each of the memory entries 304 is of equal size. However, it is appreciated that segments of unequal sizes, pages of unequal sizes and entries of unequal sizes may also be utilized.

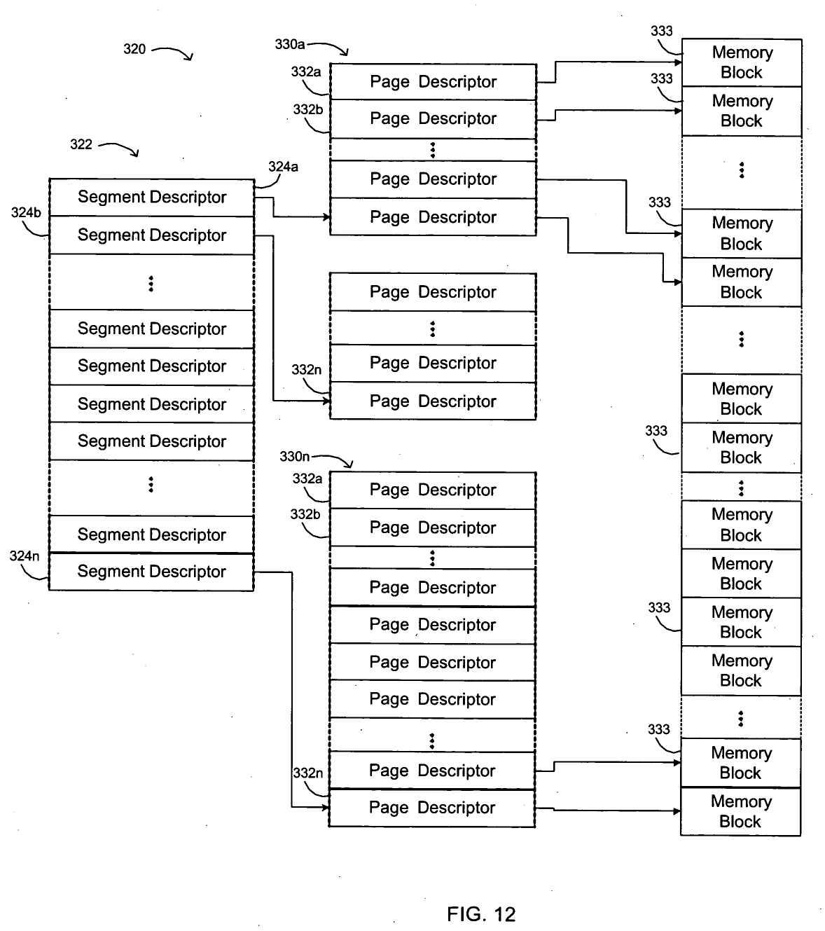

In the illustrated embodiment, the private addresses of the private address space portion 300 may be translated to system memory addresses utilizing an address translation table (ATT) which includes a set of hierarchal data structure tables, an example of which is shown schematically at 320 in FIG. 12. These tables 320 may be used to convert private address entries 304 to physical addresses of corresponding system memory entries 319.

A first hierarchal level data structure table 322, referred to herein as a segment descriptor table 322, of hierarchal data structure tables 320, has a plurality of segment descriptor entries 324a, 324b . . . 324n. Each segment descriptor entry 324a, 324b . . . 324n contains data structures, which point to a second level hierarchal data structure table referred to herein as a page descriptor table. Each page descriptor table is one of a plurality of page descriptor tables 330a, 330b . . . 330n of hierarchal data structure tables 320. Each page descriptor table 330a, 330b . . . 330n has a plurality of page descriptor entries 332a, 332b . . . 332n. Each page descriptor entry 332a, 332b . . . 332n contains data structures which provide the system memory physical address of a page or block 333 of the system memory 106.

In the illustrated embodiment, the page descriptor tables 330a, 330b . . . . . . . 330n reside within the system memory 106. It is appreciated that the page descriptor tables 330a, 330b . . . 330n may alternatively reside within the I/O device also. In the illustrated embodiment, if the number of memory entries 304 in the private address space portion 300 is represented by the variable 2^{S}, the memory entries 304 may be accessed utilizing a private address comprising s address bits as shown at 340 in FIG. 13, for example. If the number of segments 310 into which the private address space portion 300 is subdivided is represented by the variable 2^{m}, each segment 310 can describe up to 2^{(s-m)} bytes of the private address space 200.

In the illustrated embodiment, the segment descriptor table 322 may reside in memory located within the I/O device. It is appreciated however, that the segment descriptor table 322 may alternatively reside in system memory. Also, a set of bits indicated at 342 of the private address 340 may be utilized to define an index, referred to herein as a private address segment descriptor index, to identify a particular segment descriptor entry 324a, 324b . . . 324n of the segment descriptor table 322. In the illustrated embodiment, the s-m most significant bits of the s bits of the private address 340 may be used to define the private address segment descriptor index.

Once identified by the private address segment descriptor index 342 of the private address 340, the pointer of the identified segment descriptor entry 324a, 324b . . . 324n, can provide the system memory physical address of one of the plurality of page descriptor tables 330a, 330b . . . 330n (FIG. 12).

Also, a second set of bits indicated at 344 of the private address 340 may be utilized to define a second index, referred to herein as a private address page descriptor index, to identify a particular page descriptor entry 332a, 332b . . . 332n of the page descriptor table 332a, 332b . . . 332n identified by the physical address provided by the segment descriptor entry 324a, 324b . . . 324n identified by the private address segment descriptor index 342 of the private address 340. In the illustrated embodiment, the next s-m-p most significant bits of the s bits of the private address 340 may be used to define the private address page descriptor index 344.

Once identified by the physical address provided by the private address segment descriptor table entry identified by the private address segment descriptor index 342 of the private address 340, and the private address page descriptor index 344 of the private address 340, a data structure of the identified page descriptor entry 332a, 332b . . . 332n, can provide the physical address of one of the plurality of system memory pages or blocks 333 (FIG. 11).

Also, a third set of bits indicated at 346 of the private address 340 may be utilized to define a third index, referred to herein as a system memory block byte offset, to identify a particular system memory entry 319 of the system memory page or block 333 identified by the physical address provided by the page descriptor entry 332a, 332b. . . 332n identified by the private address page descriptor index 344 of the private address 340. In the illustrated embodiment, the p least significant bits of the s bits of the private address 340 may be used to define the system memory block byte offset 346 to identify a particular byte of 2^{P} bytes in a page or block 333 of bytes.

As another example of an I/O device, a device such as the storage controller 109 may optionally have an associated local memory 115 which is external to the integrated circuit or circuits with which the storage controller 109 is embodied. If an external memory 115 is coupled to the storage controller 109, a memory cluster subsystem 117 permits logic blocks within the storage controller 109 to address memory locations within the external memory 115 to read or write data.

In addition to the external memory 115, the logic blocks of the storage controller 109 may optionally address memory locations of other memory of the computer 102, such as the system memory 106, for example. Thus, if an external memory 115 is coupled to the storage controller 109, logic blocks or components within the storage controller 109 may optionally address memory locations within either the external memory 115 or the system memory 106, or both, to read or write data. However, if an external memory 115 is not coupled to the network adapter 112, logic blocks within the network adapter 112 may address memory locations within the system memory 106 and the storage 108 to read or write data.

### Additional Embodiment Details

The described techniques for managing memory may be embodied as a method, apparatus or article of manufacture using standard programming and/or engineering techniques to produce software, firmware, hardware, or any combination thereof. The term “article of manufacture” as used herein refers to code or logic embodied in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and nonvolatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are embodied may further be accessible through a transmission media or from a file server over a network. In such cases, the article of manufacture in which the code is embodied may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present descriptions, and that the article of manufacture may comprise any information bearing medium known in the art.

In the described embodiments, certain operations were described as being performed by the operating system 110, system host, device driver 120, or the network interface 112. In alterative embodiments, operations described as performed by one of these may be performed by one or more of the operating system 110, device driver 120, or the network interface 112. For example, memory operations described as being performed by the driver may be performed by the host.

In the described embodiments, a transport protocol layer 121 was embodied in the network adapter 112 hardware. In alternative embodiments, the transport protocol layer may be embodied in the device driver or host memory 106.

In certain embodiments, the device driver and network adapter embodiments may be included in a computer system including a storage controller, such as a SCSI, Integrated Drive Electronics (IDE), Redundant Array of Independent Disk (RAID), etc., controller, that manages access to a nonvolatile storage device, such as a magnetic disk drive, tape media, optical disk, etc. In alternative embodiments, the network adapter embodiments may be included in a system that does not include a storage controller, such as certain hubs and switches.

In certain embodiments, the device driver and network adapter embodiments may be embodied in a computer system including a video controller to render information to display on a monitor coupled to the computer system including the device driver and network adapter, such as a computer system comprising a desktop, workstation, server, mainframe, laptop, handheld computer, etc. Alternatively, the network adapter and device driver embodiments may be embodied in a computing device that does not include a video controller, such as a switch, router, etc.

In certain embodiments, the network adapter may be configured to transmit data across a cable connected to a port on the network adapter. Alternatively, the network adapter embodiments may be configured to transmit data over a wireless network or connection, such as wireless LAN, Bluetooth, etc.

The illustrated logic of FIGS. 8 and 10 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

FIG. 3 illustrates one embodiment of a computer architecture 500 of the network components, such as the hosts and storage devices shown in FIG. 4. The architecture 500 may include a processor 502 (e.g., a microprocessor), a memory 504 (e.g., a volatile memory device), and storage 506 (e.g., a nonvolatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a manner known in the art. The architecture further includes a network adapter 508 to enable communication with a network, such as an Ethernet, a Fibre Channel Arbitrated Loop, etc. Further, the architecture may, in certain embodiments, include a video controller 509 to render information on a display monitor, where the video controller 509 may be embodied on a video card or integrated on integrated circuit components mounted on the motherboard. As discussed, certain of the network devices may have multiple network cards or controllers. An input device 510 is used to provide user input to the processor 502, and may include a keyboard, mouse, pen-stylus, microphone, touch sensitive display screen, or any other activation or input mechanism known in the art. An output device 512 is capable of rendering information transmitted from the processor 502, or other component, such as a display monitor, printer, storage, etc.

The network adapter 508 may be embodied on a network card, such as a Peripheral Component Interconnect (PCI) card or some other I/O card, or on integrated circuit components mounted on the motherboard. The host interface may utilize any of a number of protocols including PCI EXPRESS. Details on the PCI architecture are described in “PCI Local Bus, Rev. 2.3”, published by the PCI-SIG. Details on the Fibre Channel architecture are described in the technology specification “Fibre Channel Framing and Signaling Interface”, document no. ISO/IEC AWI 14165-25. Details on the TCP protocol are described in “Internet Engineering Task Force (IETF) Request for Comments (RFC) 793,” published September 1981, details on the IP protocol are described in “Internet Engineering Task Force Request for Comments (RFC) 791, published September 1981, and details on the RDMA protocol are described in the technology specification “Architectural Specifications for RDMA over TCP/IP” Version 1.0 (October 2003).

The foregoing description of various embodiments has been presented for the purposes of illustration and description. It is not intended to be exhaustive or to limit to the precise form disclosed. Many modifications and variations are possible in light of the above teaching. It is intended that the scope be limited not by this detailed description.

What is claimed is:

1. A method, comprising:
determining whether external memory in addition to system memory is coupled to a device;
selecting a first memory which is one of said system memory and said external memory; and
mapping a first private address to be utilized by a logic block of said device to a location of said selected first memory.

2. The method of claim 1 further comprising:
receiving a request which includes said first private address from a logic block of said device; and
addressing said location of said selected first memory.

3. The method of claim 2 wherein said system memory is selected as said first memory, and said first private address is mapped to a system memory address.

4. The method of claim 1 further comprising determining if the private address of the received request has been mapped to a system memory address and translating the private address of the received request to said system memory address.

5. The method of claim 1 further comprising:
selecting a second memory which is the other of said system memory and said external memory; and
mapping a second private address to a location of said selected second memory.

6. The method of claim 5 further comprising:
receiving a request which includes said second private address from a logic block of said device; and
addressing said location of said selected second memory.

7. The method of claim 6 wherein said selected first memory has an address space and said device has a private address space, said method further comprising partitioning said private address space into at least a first partition and a second partition wherein said private address space first partition includes said first private address, and wherein said first private address mapping includes mapping said first private memory address space partition to a selected portion of said selected first memory address space.

8. The method of claim 7 wherein said selected second memory has an address space and said private address space second partition includes said second private address and wherein said second private address mapping includes mapping said second private memory address space partition to a selected portion of said selected second memory address space.

9. The method of claim 8 wherein said first memory is said system memory and said second memory is said external memory, said method further comprising routing a private address wherein said routed private address is routed to be translated to a system memory address if said routed private address is within said first partition and said routed private address is routed to said external memory if said routed private address is within said second partition.

10. An article comprising a storage medium, the storage medium comprising machine readable instructions stored thereon to:
determine whether external memory in addition to system memory is coupled to a device;
select a first memory which is one of said system memory and said external memory; and
map a first private address to be utilized by a logic block of said device to a location of said selected first memory.

11. The article of claim 10 wherein the storage medium further comprises machine readable instructions stored thereon to:
receive a request which includes said first private address from a logic block of said device; and
address said location of said selected first memory.

12. The article of claim 11 wherein said system memory is selected as said first memory, and said first private address is mapped to a system memory address.

13. The article of claim 10 wherein the storage medium further comprises machine readable instructions stored thereon to determine if the private address of the received request has been mapped to a system memory address and translate the private address of the received request to said system memory address.

14. The article of claim 10 wherein the storage medium further comprises machine readable instructions stored thereon to:
select a second memory which is the other of said system memory and said external memory; and
map a second private address to a location of said selected second memory.

15. The article of claim 14 wherein the storage medium further comprises machine readable instructions stored thereon to:
receive a request which includes said second private address from a logic block of said device; and
address said location of said selected second memory.

16. The article of claim 15 wherein said selected first memory has an address space and said device has a private address space, and wherein the storage medium further comprises machine readable instructions stored thereon to partition said private address space into at least a first partition and a second partition wherein said private address space first partition includes said first private address, and wherein said first private address mapping includes mapping said first private memory address space partition to a selected portion of said selected first memory address space.

17. The article of claim 16 wherein said selected second memory has an address space and said private address space second partition includes said second private address and wherein said second private address mapping includes mapping said second private memory address space partition to a selected portion of said selected second memory address space.

18. The article of claim 17 wherein said first memory is said system memory and said second memory is said external memory, and wherein the storage medium further comprises machine readable instructions stored thereon to route a private address wherein said routed private address is routed to be translated to a system memory address if said routed private address is within said first partition and said routed private address is routed to said external memory if said routed private address is within said second partition.

19. A system for use with a network, comprising:
at least one system memory which includes an operating system;
a processor coupled to the memory;
data storage;
a data storage controller for managing Input/Output (I/O) access to the data storage;
a network adapter having a plurality of logic blocks and a memory controller which is coupled to said system memory;
at least one of said system memory and an external memory external to said adapter; and
a device driver executable by the processor in the system memory, wherein the device driver is adapted to:
determine whether external memory in addition to system memory is coupled to the adapter memory controller;
select a first memory which is one of said system memory and said external memory; and
map a first private address to be utilized by a logic block of said adapter to a location of said selected first memory.

20. The system of claim 19 wherein the memory controller is adapted to:
receive a request which includes first said private address from a logic block of said adapter; and
address said location of said selected first memory.

21. The system of claim 20 wherein said system memory is selected as said first memory, and said first private address is mapped to a system memory address.

22. The system of claim 19 wherein the memory controller is further adapted to determine if the private address of the received request has been mapped to a system memory address and translate the private address of the received request to said system memory address.

23. The system of claim 19 wherein the device driver is adapted to:
select a second memory which is the other of said system memory and said external memory; and
map a second private address to a location of said selected second memory.

24. The system of claim 23 wherein the memory controller is further adapted to:
receive a request which includes said second private address from a logic block of said adapter; and
address said location of said selected second memory.

25. The system of claim 24 wherein said selected first memory has an address space and said adapter has a private address space, and wherein the device driver is further adapted to partition said private address space into at least a first partition and a second partition wherein said private address space first partition includes said first private address, and wherein said first private address mapping includes mapping said first private memory address space partition to a selected portion of said selected first memory address space.

26. The system of claim 25 wherein said selected second memory has an address space and said private address space second partition includes said second private address and wherein said second private address mapping includes mapping said second private memory address space partition to a selected portion of said selected second memory address space.

27. The system of claim 26 wherein said first memory is said system memory and said second memory is said external memory, and wherein the memory controller is further adapted to route a private address wherein said routed private address is routed to be translated to a system memory address if said routed private address is within said first partition and said routed private address is routed to said external memory if said routed private address is within said second partition.

28. A network adapter for use with at least one of a system memory, a device driver, and an external memory external to said adapter, said adapter comprising:
a plurality of logic blocks adapted to provide memory requests having private addresses; and
a memory controller which is adapted to be coupled to at least one of said system memory and external memory, wherein said memory controller has control register logic adapted to be responsive to control bits settable in said control register logic by said driver to:
select a first memory which is one of said system memory and said external memory; and
map a first private address to be provided by a logic block of said adapter to a location of said selected first memory.

29. The adapter of claim 28 wherein the memory controller is adapted to:
receive a request which includes said first private address from a logic block of said adapter; and
address said location of said selected first memory.

30. The adapter of claim 29 wherein said system memory is selected as said first memory, and said first private address is mapped to a system memory address.

31. The adapter of claim 28 wherein the memory controller is further adapted to determine if the private address of the received request has been mapped to a system memory address and translate the private address of the received request to said system memory address.

32. The adapter of claim 28 wherein said memory controller control register logic is adapted to be responsive to control bits settable in said control register logic by said driver to:
select a second memory which is the other of said system memory and said external memory; and
map a second private address to a location of said selected second memory.

33. The adapter of claim 32 wherein the memory controller is further adapted to:
receive a request which includes said second private address from a logic block of said adapter; and
address said location of said selected second memory.

34. The adapter of claim 33 wherein said selected first memory has an address space and said adapter has a private address space, and wherein said memory controller control register logic is adapted to be responsive to control bits settable in said control register logic by said driver to partition said private address space into at least a first partition and a second partition wherein said private address space first partition includes said first private address, and wherein said first private address mapping includes mapping said first private memory address space partition to a selected portion of said selected first memory address space.

35. The adapter of claim 34 wherein said selected second memory has an address space and said private address space second partition includes said second private address and wherein said second private address mapping includes mapping said second private memory address space partition to a selected portion of said selected second memory address space.

36. The adapter of claim 35 wherein said first memory is said system memory and said second memory is said external memory, and wherein the memory controller further comprising address translation logic adapted to translate a private address to a system memory address, said memory controller further including router logic adapted to route a private address wherein said routed private address is routed to be translated by said address translation logic to a system memory address if said routed private address is within said first partition and said routed private address is routed to said external memory if said routed private address is within said second partition.
